(19) United States
(12) Patent Application Publication
(10) Pub. No.: US 2011/0146493 A1
(43) Pub. Date: Jun. 23, 2011

(54) FILTER BAG AND LAMINATED FILTER MEDIA

(75) Inventors: Gopakumar Thottupurathu, Overland Park, KS (US); Alan Smithies, Overland Park, KS (US)

(73) Assignee: General Electric Company

(21) Appl. No.: 12/644,524

(22) Filed: Dec. 22, 2009

(51) Int. Cl. B01D 69/10; B01D 65/02; B01D 69/12

(52) U.S. Cl. 96/12; 96/11

(57) ABSTRACT

A filter assembly for use in a baghouse having a tubesheet with an opening therethrough. The filter assembly comprises a cage connectible with the tubesheet adjacent the opening. The cage includes wire members. A filter bag is supported by the wire members of the cage to maintain the filter bag in an operational condition and in fluid communication with the opening in the tubesheet. A reverse pulse jet cleaning system positioned to direct a cleaning pulse through the opening and into the filter bag for a plurality of cleaning cycles. The filter bag is made from laminated filter media. The laminated filter media includes a fabric substrate. The laminated filter media also includes a membrane laminated to the fabric substrate, the membrane comprising a single layer of expanded material of co-coagulated polytetrafluoroethylene with titanium dioxide particles. The titanium dioxide particles are present in the co-coagulated polytetrafluoroethylene in a range of about 0.5 wt % to 4.5 wt %.

### BACKGROUND OF THE INVENTION

The present invention is generally directed to a filter assembly for use in a dust collector. In particular, the present invention is directed to a filter bag and laminated filter media.

Dust collectors, such as baghouses, for filtering particulate-laden gas are well known. A typical baghouse has a housing with a dirty gas chamber and a clean gas chamber. The two chambers are separated by a tubesheet. The tubesheet has a number of openings through which filters, such as filter bags, typically extend. The filter bags are suspended from the tubesheet and extend into the dirty gas chamber. Particulate-laden gas is introduced into the dirty gas chamber. The gas passes through the filter bags and through the openings in the tubesheet into the clean air chamber. The particulates are separated from the gas flow by the filter bags. The filtered gas is exhausted from the clean gas chamber or directed for other uses.

The filter bag typically extends over and is supported by a wire cage. The cage prevents “collapse” of the filter bag during gas flow through the filter bag in a normal filtering direction. The filter bag is also typically subject to cleaning cycles in which a pressurized pulsed jet of a gas, such as air, is sent through the filter bag in a direction opposite to the normal filtering flow direction. Depending on the application that the dust collector is used in, the filter bag could be made from a laminated filter media. The laminated filter media of the filter bag tends to be damaged by repeated cleaning cycles. The damage decreases the filtration efficiency and service life of the laminated filter media of the filter bag. It is, therefore, desirable to have a filter bag and laminated filter media that can withstand a relatively greater number of cleaning cycles without damage than heretofore know filter bags and laminated filter media.

### BRIEF DESCRIPTION OF THE INVENTION

The invention, according to at least one aspect, offers an improved laminated media and filter bag. The improved laminated filter media and filter bag provide a relatively longer service life while maintaining relatively high filtration efficiency, relatively high air permeability and relatively low pressure drop.

One aspect of the invention is a filter assembly for use in a baghouse having a tubesheet with an opening therethrough. The filter assembly comprises a cage connectible with the tubesheet adjacent the opening. The cage includes wire members. A filter bag is supported by the wire members of the cage to maintain the filter bag in an operational condition and in fluid communication with the opening in the tubesheet. A reverse pulse jet cleaning system positioned to direct a cleaning pulse through the opening and into the filter bag for a plurality of cleaning cycles. The filter bag is made from laminated filter media. The laminated filter media includes a fabric substrate. The laminated filter media also includes a membrane laminated to the fabric substrate. The membrane comprises a single layer of expanded material of co-coagulated polytetrafluoroethylene with titanium dioxide particles. The titanium dioxide particles are present in the co-coagulated polytetrafluoro-ethylene in a range of about 0.5 wt % to 4.5 wt %.

Another aspect of the invention is a filter bag for use in a baghouse having a tubesheet with an opening therethrough. A wire cage is connectible with the tubesheet adjacent the opening to support the filter bag and maintain the filter bag in an operational condition and in fluid communication with the opening in the tubesheet. A reverse pulse jet cleaning system is positioned to direct a cleaning pulse through the opening and into the filter bag. The filter bag is made from a laminate. The laminate comprises a fabric substrate. The laminate also comprises a membrane laminated to the fabric substrate. The membrane comprises a single layer of expanded material of co-coagulated polytetrafluoroethylene resin with titanium dioxide particles. The titanium dioxide particles are present in the co-coagulated polytetrafluoroethylene resin in a range of about 0.5 wt % to 4.5 wt %. The laminate of the filter bag has an air permeability at 30,000 cleaning cycles of at least about 40% of its initial air permeability per ASTM D737.

Another aspect of the invention is a filter media for use in an industrial pollution control filter bag. The filter media comprises a fabric substrate. The filter media also comprises a membrane laminated to the fabric substrate. The membrane comprises a single layer of expanded material of co-coagulated polytetrafluoroethylene resin with titanium dioxide particles. The titanium dioxide particles are present in the co-coagulated polytetrafluoroethylene resin in a range of about 0.5 wt % to 4.5 wt %.

### BRIEF DESCRIPTION OF THE DRAWINGS

Further features of the invention will become apparent to those skilled in the art to which the invention relates from reading the following description with reference to the accompanying drawings, in which:

FIG. 1 is a schematic sectional view of a reverse pulse jet baghouse illustrating a plurality of filter bags according to one aspect of the invention;

FIG. 2 is an enlarged view of a portion of the reverse pulse jet baghouse illustrated in FIG. 1;

FIG. 3 is a perspective view of laminated filter media, according to one aspect of the invention, for use in the filter bags illustrated in FIGS. 1-2;

FIG. 4 is an enlarged cross-sectional view of a portion of the laminated filter media illustrated in FIG. 3;

FIG. 5 is a graphical representation of test results for laminated filter media illustrating air permeability as a function of cleaning cycles;

FIG. 6 is a graphical representation of test results for laminated filter media illustrating dust penetration as a function of cleaning cycles; and

FIG. 7 is a graphical representation of test results for laminated filter media illustrating pressure drop as a function of cleaning cycles.

### DETAILED DESCRIPTION OF THE INVENTION

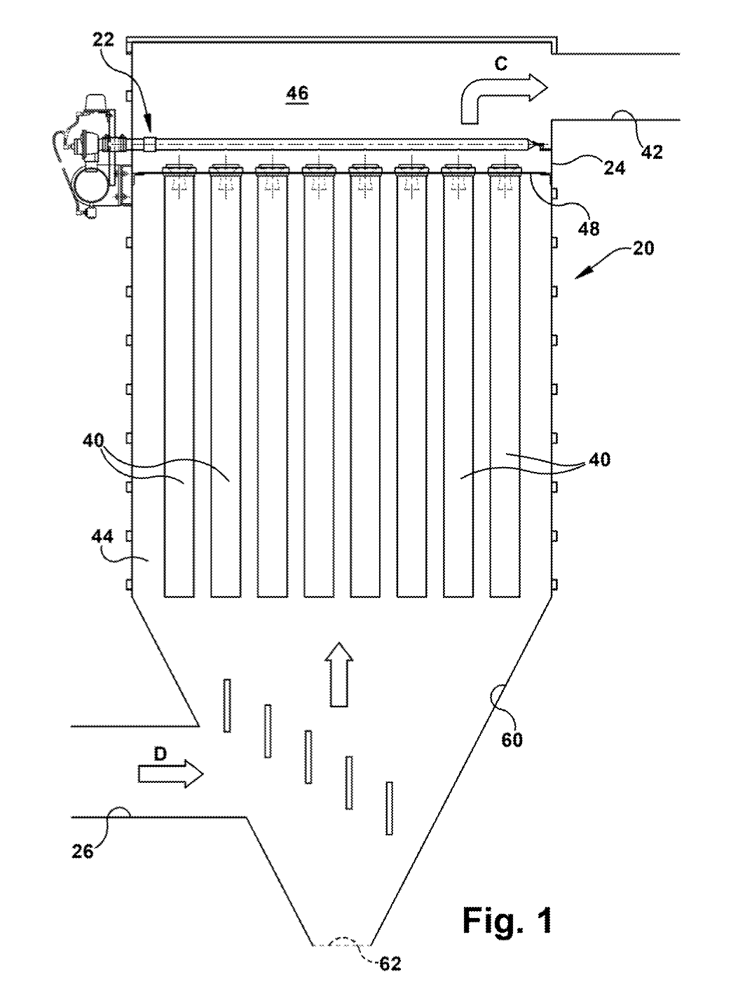

A dust collector or baghouse 20 having a reverse pulse filter cleaning system 22 is illustrated in FIG. 1. The baghouse 20 includes an enclosed housing 24 that supports the reverse pulse filter cleaning system 22. The housing 24 is made from a suitable material, such as sheet metal. Particulate-laden gas D flows into the baghouse 20 from an inlet 26. The particulate-laden gas D is filtered by a plurality of relatively long filter assemblies 40, according to an aspect of the invention, located within the baghouse 20. Filtered or clean gas C exits through an outlet 42 of the baghouse 20.

The baghouse 20 is divided into a “dirty gas” plenum 44 and a “clean gas” plenum 46 by a tubesheet 48 made from a suitable material, such as sheet metal. The inlet 26 is in fluid communication with the dirty gas plenum 44. The outlet 42 is in fluid communication with the clean gas plenum 46.

The baghouse 20 also has an accumulation chamber defined by sloped walls 60 located at a lower end of the dirty gas plenum 44. The accumulation chamber receives and temporarily stores particulates and other debris that were separated from the particulate-laden gas D or fall off of the filter assemblies 40. The stored particulates and debris exit the accumulation chamber through an opening 62.

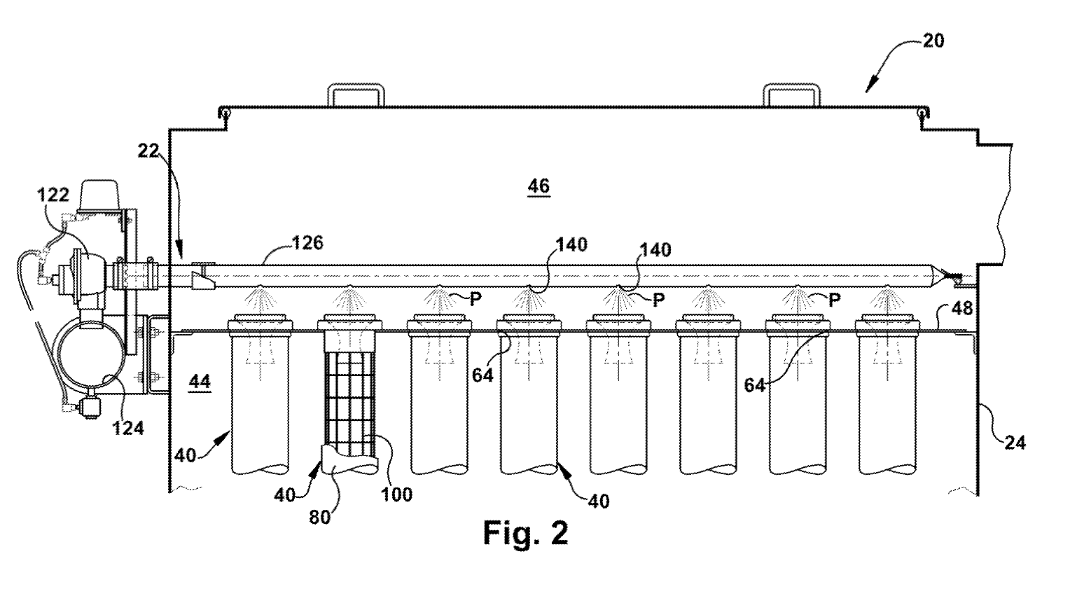

A plurality of openings 64 (FIG. 2) extend through the tubesheet 48. A filter assembly 40, constructed according to one aspect of the invention, is installed in a respective opening 64. Each of the filter assemblies 40 is mounted within the respective opening 64 so it seals against the tubesheet 48. Any suitable mounting structure may be used to attach, support and seal the filter assemblies 40 to the tubesheet 48.

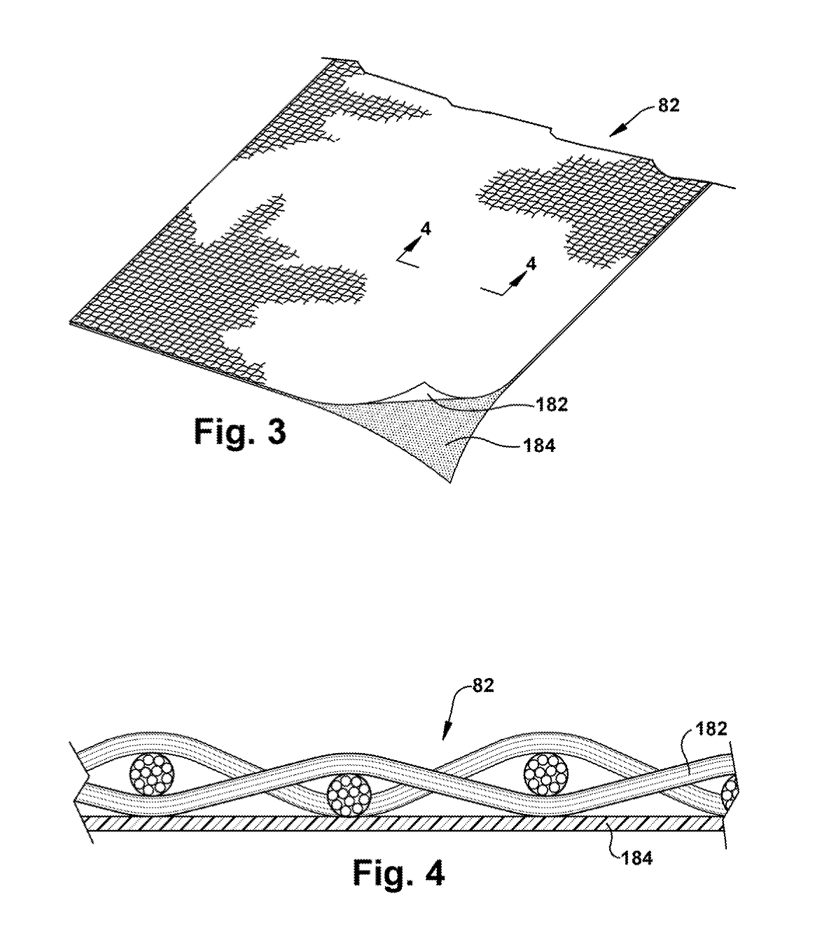

The filter assemblies 40 filter particulates from the particulate-laden gas D as the gas passes through each filter assembly. Each filter assembly 40 includes a filter bag 80 made from laminated filter media 82 (FIG. 3). The filter bag 80 is formed into a tubular configuration with a circular cross-section. It will be apparent that the filter assembly 40 may be any desired length in order to meet the filtering requirements of the baghouse 20.

The filter bag 80 is located concentrically around a support member of the filter assembly 40, such as a cage 100. The filter bag 80 is located about the perimeter of the cage 100. The cage 100 is made from a plurality of longitudinally extending wire members interconnected by a plurality of circumferentially extending wire members. The filter bag 80 and cage 100 have respective lengths or axial extents that are dependant on the requirements of the design of the baghouse 20. The filter bag 80 may be constructed of any suitable material for desired filtering requirements and operating conditions.

The reverse pulse cleaning system 22 includes a pulse valve 122 (FIGS. 1 and 2). The pulse valve 122 is fluidly connected to a compressed air manifold or header 124 that supplies compressed fluid, such as air. The pulse valve 122 is arranged to direct compressed air stored in the header 124 through blowpipe 126. The blowpipe 126 is supported by the housing 24.

The blowpipe 126 has a plurality of nozzles 140. The nozzle 140 defines a passage for the cleaning air delivered from the blowpipe 126. The nozzles 140 are positioned a predetermined distance from the tubesheet 24 and located along the longitudinal central axis of a respective filter assembly 40, as illustrated in FIG. 2. Periodically, the pulse valve 122 is actuated to allow a pulse P of compressed air to flow from the manifold 124, to the blowpipe 126, through the nozzles 140 and into the filter assemblies 40 while filtering operation of the baghouse 20 continues. The baghouse 20 does not have to be shut down during this cleaning operation so it does not go off-line.

After a period of filtering operation of the baghouse 20, a pressure drop across each of the filter assemblies 40 will increase due to the accumulation at the outer surfaces of the filter bags 80 of particulates separated from the particulate-laden gas flow D. The filter assemblies 40 are periodically cleaned by directing pulses P (FIG. 2) of a cleaning gas, such as compressed air, into the open end of each of the filter assemblies. This cleaning is referred to as reverse pulse cleaning.

The reverse cleaning pulse P is directed into each filter assembly 40, in a diverging pattern along a longitudinal central axis of the filter cartridge. The reverse cleaning pulse P flows from the inside of the filter assembly 40 through the filter bag 80 to the outside of the filter assembly in a “reverse” or opposite direction to normal filtering gas flow. This cleaning pulse P will remove at least some, and preferably a significant amount, of the particulates accumulated at the outer surface of the filter assembly 40 and reduce the pressure drop across the filter assembly.

Referring to FIG. 1, the reverse pulse cleaning system 22 according to one aspect of the invention is illustrated. The reverse cleaning pulse P is provided by the cleaning system 22. Directing a cleaning pulse P of compressed air is done periodically into each filter assembly 40 through its open end. By “periodic”, it is meant that the reverse pulse cleaning system 22 can be programmed or the system can be manually operated such that at selected times there will be a cleaning pulse P of compressed air directed into the filter assembly 40. For example, the selected time could be after a predetermined duration or after a certain amount of pressure drop across the filter assemblies 40 is detected.

The cleaning pulse P emerging from the nozzle 140 creates a pressure wave along the longitudinal extent of the filter assemblies 40. Due to the suddenly occurring pressure change and the reversal of the flow direction, the filter bag 80 and accumulated particulate buildup are forced radially outward from the cage 100. This repeated movement creates a bending moment of the laminated filter media 82 over the wires of the cage 100 that can cause damage to the laminated filter media. The damage can reduce filtration efficiency.

The accumulated particulate buildup is separated from the outer surfaces of the filter bag 80. The separated accumulated particulate buildup drops into the accumulation chamber and exits the baghouse 20 through the opening 62. The particulates can then be carried away from the baghouse 20, for instance, by means of a screw conveyor (not shown).

The laminated filter media 82 of the filter bags 80 (FIGS. 3-4) includes at least two layers in the form of a fabric substrate 182 and a fine filtration membrane 184. The membrane 184 is laminated to the fabric substrate 182, by any suitable means, such as thermal or adhesive lamination. The membrane 184 is intended to be located upstream of the fabric substrate during normal filtering gas flow through the laminated filter media 82 of the filter bag 80. The fabric substrate 182 may be of any suitable form and material. The fabric substrate 182 is illustrated as being woven from fiberglass. The fabric substrate 182 may be a woven or non-woven material such as acrylic, aramid, fiberglass, P84, polyester, polyphenylene sulphide, polypropylene and polytetrafluoroethylene.

The membrane 184 according to one aspect is porous, and preferably microporous, with a three-dimensional matrix or lattice type structure of numerous nodes interconnected by numerous fibrils. The material that the membrane 184 is made from any suitable material but is preferably made of expanded polytetrafluoroethylene (ePTFE) that has preferably been at least partially sintered.

Surfaces of the nodes and fibrils define numerous interconnecting pores that extend completely through the membrane 184 between opposite major side surfaces of the membrane in a tortuous path. A suitable average size for the pores in the membrane 184 may be in the range of 0.01 to 10 microns, and preferably in the range of 1.0 to 5.0 microns.

Generally, the membrane 184 is preferably made by extruding a mixture of a modified polytetrafluoroethylene (PTFE) fine powder particles and lubricant. The extrudate is then calendared. The calendared extrudate is then “expanded” or stretched in at least one and preferably two directions to form the fibrils connecting the nodes in a three-dimensional matrix or lattice type of structure. “Expanded” is intended to mean sufficiently stretched beyond the elastic limit of the material to introduce permanent set or elongation to the fibrils. The membrane 184 is preferably then heated or “sintered” to reduce and minimize residual stress in the membrane material. However, the membrane 184 may be unsintered or partially sintered as is appropriate for the contemplated use of the membrane.

The membrane 184 according to one aspect of the invention contains metal oxide particles. It has been found that such a membrane 184 has significantly improved properties, such as increased abrasion resistance, increased tensile strength, increased tensile modulus, that may enhance the mechanical stability and/or durability of the membrane.

The membrane 184 is preferably a single layer of the modified polytetrafluoroethylene (PTFE). A suitable modified polytetrafluoroethylene (PTFE) resin has been found to be co-coagulated polytetrafluoroethylene with titanium dioxide particles that is available from Solvay under the name XPH. The modified polytetrafluoroethylene (PTFE) resin is mixed with a suitable lubricating agent. The titanium dioxide particles are present in the co-coagulated polytetrafluoroethylene in a range of about 0.5 wt % to 4.5 wt % and preferably in a range of about 1.5 wt % to 3.0 wt %. The size of the titanium dioxide particles is in the range of 150 to 250 nanometers.

The modified PTFE resin may be mixed with the lubricating agent in a V blender for between 1 and 60 minutes (preferably about 20 minutes), for example, until the mixture is approximately homogenous. A suitable lubricating agent includes a hydrocarbon-based liquid, such as the isoparaffinic solvents sold under the Isopar tradename by the ExxonMobil Chemical Co. A preferred lubricating agent includes Isopar K, Isopar M. and/or Isopar G. In certain embodiments, the weight percentage of the lubricating agent may range between 15 and 23% of weight of the resin while maintain the temperature below 50° F. This weight percentage is commonly known as the “lube rate” may vary, for example, depending on the specific processing parameters of the equipment being used in the extrusion process.

Wicking occurs after mixing, and the resin/lubricant mixture may be held at a temperature of 80° F. to 100° F. for up to 24 hours. In certain aspects, the temperature may be higher (e.g., 200° F.) or lower (e.g., 40° F.), and the time may be shorter (e.g., 1 hour) or longer (e.g. 120 hours). In other embodiments, the wicking may be optional.

The resin/lubricant mixture is then placed into a cylinder. The mixture is then pressed under pressure to yield a preform. In some aspects, the cylinder may be 50 inches long and 1 to 5 inches in inner diameter, and the 150 psi of pressure is used to force the mixture into the preform at ambient temperature. Of course, other process parameters may also be used.

The preform is extruded into a tape by a ram extruder. In some aspects, the extrusion occurs at a temperature between 90° F. and 110° F. The final thickness of the tape may vary between 5 and 75 mils and preferably between 35 and 45 mils. Of course, other process parameters may also be used.

After extrusion, the tape is calendered, by passing the tape through hot calender rolls to obtain a desired tape as well as stretching in the machine direction to form fibrils. The calendering may occur at a temperature between 300° F. and 400° F. and at suitable rate such as between 10 and 20 ft/min. After calendering, the tape may be passed over additional rolls to evaporate the lubricating agent from the tape. Of course, other process parameters may also be used.

The calendered tape is then further stretched in the machine direction (MD) between one to ten times. The MD stretched tape is the formed into the membrane 184 by a tentering operation. During this process, the MD stretched tape is stretched in the transverse or cross direction to form the relatively thin membrane 184. Preferably, the stretching occurs at a line speed between 30 ft/mm and 80 ft/mm. The MD stretched tape may be stretched between 1 and 20 times (preferably between 10 and 12 times) in the transverse direction. The tape may be exposed to various temperatures during the tentering operation, such as between 150° F. and 800° F. or for example, at 200° F., at 500° F., at 650° F., or at 700° F. These temperatures may increase or otherwise vary with the stretch cycles or locations within the tenter.

After tentering, the membrane 184 may be heat treated to stabilize the microstructure of a membrane. This sintering may occur in an oven at a temperature between 400° F. and 750° F., preferably between 650° F. and 750° F., for a period of time between 1 and 120 seconds, and preferably between 10 and 30 seconds. The final thickness of the membrane 184 may range between 0.05 and 20 mil and preferably about 0.1 to 2 mil.

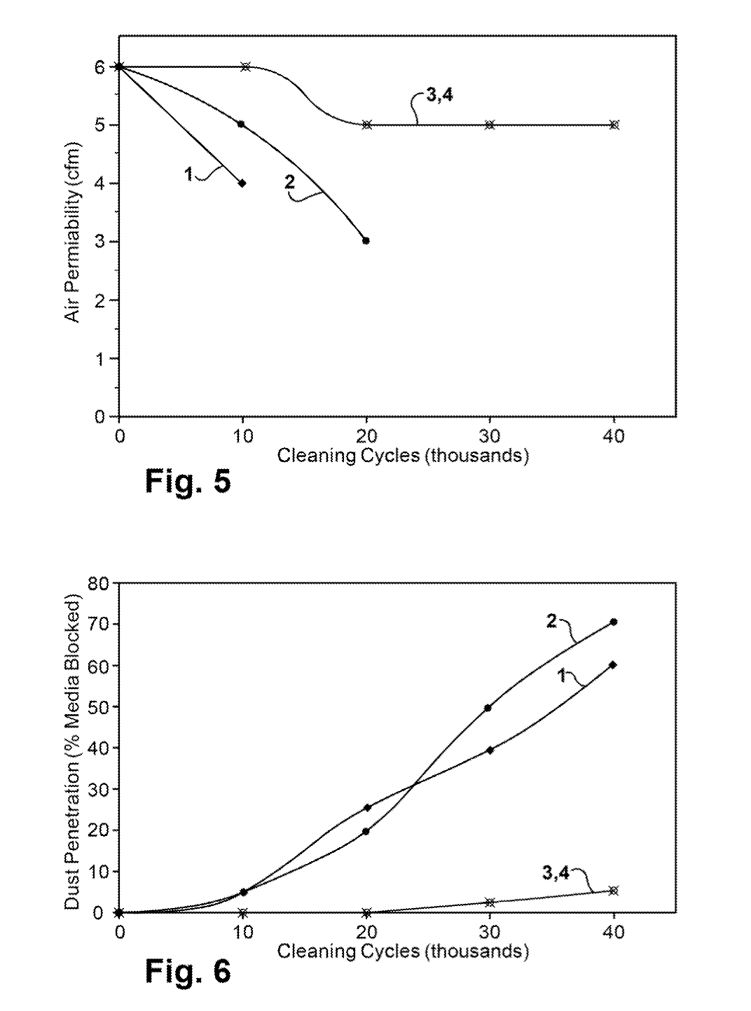

Exemplary samples of the laminated filter media 82 were prepared for comparison testing to known filter bags. The laminated filter media 82 was formed into filter bags 80 and tested in a controlled test baghouse. The filter bags 80 were periodically removed from the test baghouse for performance testing. The laminates 82 of the filter bags 80 were tested as per know industry test methods. The results of comparison testing is illustrated in FIGS. 5-7.

Sample 1 was selected as one known baseline filter bag product for testing. Sample 1 represents a known expanded polytetrafluoroethylene membrane laminated to a known aramid fabric substrate (NOMEX®) that is commercially available as a filter bag as part number QN004 from BHA Group, Inc.

Sample 2 was also selected as one known baseline product for testing. Sample 2 represents a known expanded polytetrafluoroethylene membrane laminated to a known fiberglass fabric substrate that is commercially available as a filter bag as part number QG061 from BHA Group, Inc.

Sample 3 was prepared for testing. Sample 3 includes the membrane 184, made according to one aspect of the invention and described above, that includes expanded material of co-coagulated polytetrafluoroethylene with titanium dioxide particles. The membrane 184 is laminated to the known aramid fabric substrate 182 (NOMEX®) of Sample 1.

Sample 4 was also prepared for testing. Sample 4 includes the membrane 184, made according to one aspect of the invention and described above, that includes expanded material of co-coagulated polytetrafluoroethylene with titanium dioxide particles. The membrane 184 is laminated to the known fiberglass fabric substrate 182 of Sample 2.

Air permeability according to industry standard testing (ASTM D737) of the samples over cleaning cycles is shown on the graph in FIG. 5. Sample 1 lost about one third of its air permeability at 10,000 cleaning cycles. It was determined that Sample 1 was damaged, as typically seen in service, and removed from further air permeability testing. Sample 2 lost about one half of its air permeability at 20,000 cleaning cycles. It was determined that Sample 2 was damaged, as typically seen in service, and removed from further air permeability testing. Samples 3 and 4 lost only about 17% of its initial air permeability at 20,000 through 40,000 cleaning cycles. Samples 3 and 4 were undamaged at this point and still deemed to be serviceable. This is evidence that the laminated filter media 82 of the filter bag 80, due to the incorporation of the new membrane 184, is significantly more durable in the simulated filtration application than previously known laminates for filter bags. Thus, the filter assembly 40, filter bag 80 and laminated filter media 82 display an improved air permeability at 30,000 cleaning cycles per ASTM D737 of at least about 40% of its initial air permeability, preferably at least about 67% and more preferably at least about 80%. In other words, the filter assembly 40, filter bag 80 and laminated filter media 82 display an improved air permeability at 30,000 cleaning cycles per ASTM D737 of at least about 2.4 CFM, preferably at least about 4.0 CFM and more preferably at least about 4.8 CFM.

Dust penetration of the samples over cleaning cycles is shown on the graph in FIG. 6. Dust penetration is defined here as the percentage of the surface area of the filtration media that is blocked by challenge dust that cannot be cleaned by reverse pulse cleaning. Dust penetration is, thus, indicative of the ability of the laminated filter media 82 to be cleaned which affects air permeability and pressure drop. Samples 1 and 2 have a substantial percentage (40% and 50%, respectively at 30,000 cleaning cycles and 60% and 70%, respectively at 40,000 cleaning cycles) of the filtration media blocked over the duration of the test. Samples 3 and 4 have a relatively smaller percentage (about 3% at 30,000 cleaning cycles and about 5% at 40,000 cleaning cycles) of the filtration media blocked over the duration of the test. This is evidence that the laminated filter media 82 of the filter bag 80, due to the new membrane 184, is significantly more cleanable in the simulated filtration application than previously known laminates.

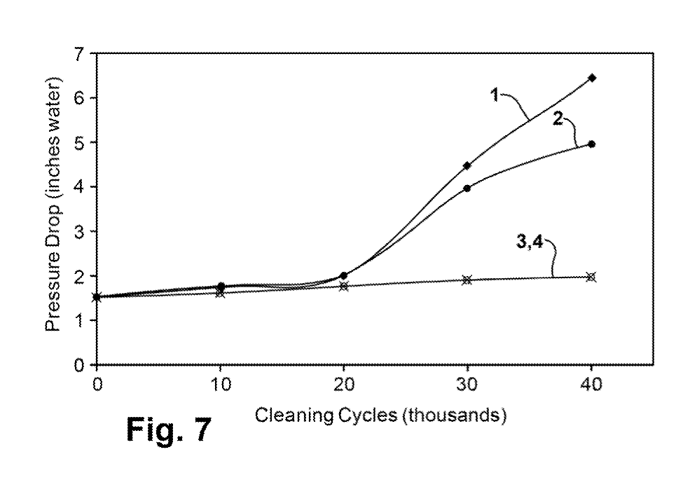

Pressure drop according to industry standard testing (ASTM D6830) of the samples over cleaning cycles is shown on the graph in FIG. 7. All of the samples performed substantially the same through about 20,000 cleaning cycles. Samples 1 and 2, at about 30,000 cleaning cycles, experienced a pressure drop that about doubled from its initial pressure drop. For samples 1 and 2, at about 40,000 cleaning cycles, the pressure drop further increased. Samples 3 and 4 experienced only a slight increase a pressure from its initial pressure drop at 30,000 and 40,000 cleaning cycles. This is evidence that the laminated filter media 82 of the filter bag 80, due to the new membrane 184, is significantly more durable in the simulated filtration application than previously known laminates due to its cleanability without an increase in pressure drop. Thus, the filter assembly 40, filter bag 80 and laminated filter media 82 display significantly improved pressure drop results (being less than about 3.0 inches of water determined by ASTM D6830 testing) across the laminated filter media of the filter bag at 30,000 cleaning cycles. In other words, the filter assembly 40, filter bag 80 and laminated filter media 82 display improved pressure drop results across the laminated filter media 82 of the filter bag 80 determined by ASTM D6830 testing at 30,000 cleaning cycles by increasing by less than 100% of the initial pressure drop.

From the above description of at least one aspect of the invention, those skilled in the art will perceive improvements, changes and modifications. Such improvements, changes and modifications within the skill of the art are intended to be covered by the appended claims. All disclosed and claimed numbers and numerical ranges are approximate and include at least some variation and deviation.

What is claimed is:

1. A filter assembly for use in a baghouse having a tubesheet with an opening therethrough, the filter assembly comprising:
a cage connectible with the tubesheet adjacent the opening, the cage including wire members;
a filter bag supported by the wire members of the cage to maintain the filter bag in an operational condition and in fluid communication with the opening in the tubesheet;
a reverse pulse jet cleaning system positioned to direct a cleaning pulse through the opening and into the filter bag for a plurality of cleaning cycles; and
the filter bag made from laminated filter media including:
a fabric substrate; and
a membrane laminated to the fabric substrate, the membrane comprising a single layer of expanded material of co-coagulated polytetrafluoroethylene with titanium dioxide particles, wherein the titanium dioxide particles are present in the co-coagulated polytetrafluoroethylene in a range of about 0.5 wt % to 4.5 wt %.

2. The filter assembly of claim 1 wherein the titanium dioxide particles have a size in the range of 150 to 250 nanometers.

3. The filter assembly of claim 1 wherein the laminated filter media of the filter bag has an air permeability at 30,000 cleaning cycles per ASTM D737 of at least about 2.4 CFM.

4. The filter assembly of claim 1 wherein the laminated filter media of the filter bag has an air permeability at 30,000 cleaning cycles per ASTM D737 of at least about 40% of its initial air permeability.

5. The filter assembly of claim 1 wherein the pressure drop across the laminated filter media of the filter bag at 30,000 cleaning cycles is less than about 3.0 inches of water determined by ASTM D6830 testing.

6. The filter assembly of claim 1 wherein the pressure drop across the laminated filter media of the filter bag determined by ASTM D6830 testing at 30,000 cleaning cycles increases by less than 100% from the initial pressure drop across the filter bag.

7. The filter assembly of claim 1 wherein the fabric substrate comprises a woven or non-woven material selected from the group including acrylic, aramid, fiberglass, P84, polyester, polyphenylene sulphide, polypropylene and polytetrafluoroethylene.

8. A filter bag for use in a baghouse having a tubesheet with an opening therethrough, a wire cage connectible with the tubesheet adjacent the opening to support the filter bag and maintain the filter bag in an operational condition and in fluid communication with the opening in the tubesheet and a reverse pulse jet cleaning system positioned to direct a cleaning pulse through the opening and into the filter bag, the filter bag made from a laminate comprising:
a fabric substrate; and
a membrane laminated to the fabric substrate, the membrane comprising a single layer of expanded material of co-coagulated polytetrafluoroethylene resin with titanium dioxide particles, wherein the titanium dioxide particles are present in the co-coagulated polytetrafluoroethylene resin in a range of about 0.5 wt % to 4.5 wt % and wherein the laminate of the filter bag has an air permeability at 30,000 cleaning cycles of at least about 40% of its initial air permeability per ASTM D737.

9. The filter bag of claim 8 wherein the titanium dioxide particles have a size in the range of 150 to 250 nanometers.

10. The filter bag of claim 8 wherein the laminate of the filter bag has an air permeability at 30,000 cleaning cycles of at least about 2.4 CFM determined by ASTM D737 testing.

11. The filter assembly of claim 8 wherein the pressure drop across the laminate of the filter bag at 30,000 cleaning cycles is less than about 3.0 inches of water determined by ASTM D6830 testing.

12. The filter assembly of claim 8 wherein the pressure drop across the laminate of the filter bag determined by ASTM D6830 testing at 30,000 cleaning cycles increases by less than 100% from the initial pressure drop across the filter bag.

13. The filter assembly of claim 8 wherein the fabric substrate comprises a woven or non-woven material selected from the group including acrylic, aramid, fiberglass, P84, polyester, polyphenylene sulphide, polypropylene and polytetrafluoroethylene.

14. Filter media for use in an industrial pollution control filter bag, the filter media comprising:
a fabric substrate; and
a membrane laminated to the fabric substrate, the membrane comprising a single layer of expanded material of co-coagulated polytetrafluoroethylene resin with titanium dioxide particles, wherein the titanium dioxide particles are present in the co-coagulated polytetrafluoro-ethylene resin in a range of about 0.5 wt % to 4.5 wt %.

15. The filter media of claim 14 wherein the titanium dioxide particles have a size in the range of 150 to 250 nanometers.

16. The filter media of claim 14 wherein the fabric substrate comprises a woven or non-woven material selected from the group including acrylic, aramid, fiberglass, P84, polyester, polyphenylene sulphide, polypropylene and polytetrafluoroethylene.

17. The filter media of claim 14 wherein the filter media has an air permeability at 30,000 cleaning cycles per ASTM D737 of at least about 40% of its initial air permeability.

18. The filter media of claim 14 wherein the filter media has an air permeability at 30,000 simulated cleaning cycles per ASTM D737 of at least about 2.4 CFM.

19. The filter media of claim 14 wherein the pressure drop across the filter media at 30,000 simulated cleaning cycles is less than about 3.0 inches of water determined by ASTM D6830 testing.

20. The filter assembly of claim 14 wherein the pressure drop across the filter media determined by ASTM D6830 testing at 30,000 cleaning cycles increases by less than 100% from the initial pressure drop across the filter bag.
